(19) United States
(12) Patent Application Publication
(10) Pub. No.: US 2026/0161884 A1
(43) Pub. Date: Jun. 11, 2026

(54) MULTI-CHAIN GENERATIVE ARTIFICIAL INTELLIGENCE

(71) Applicant: Paypal, Inc., San Jose, CA (US)

(72) Inventors: Dayu Zhu, Bryan, TX (US); Yi Yang, Manhasset, NY (US); Yun Wang, Scarsdale, NY (US); Yunxia Zhao, Tempe, AZ (US); Kwan Wing Yip, Austin, TX (US)

(21) Appl. No.: 18/972,710

(22) Filed: Dec. 6, 2024

(51) Int. Cl. G06F 40/177; G06F 40/103; G06F 40/186; G06F 40/205; G06F 40/284

(52) U.S. Cl. CPC G06F 40/177; G06F 40/103; G06F 40/186; G06F 40/205; G06F 40/284

(57) ABSTRACT

The disclosed computer-implemented method may include preprocessing documents for indexing into different document databases for different content types, and prompting language models to retrieve relevant documents of the different content types from the document databases and generate document summaries for each of the different content types. The method may also include prompting the language models with a document template incorporating the different content types to generate a formatted document from the document summaries. Various other methods, systems, and computer-readable media are also disclosed.

### TECHNICAL FIELD

The present disclosure is directed to generative artificial intelligence (Gen AI), which may refer to machine learning models that may generate one or more types of data, such as text, images, videos, and/or combinations thereof. Large language models (LLMs) are often artificial neural networks designed for natural language processing tasks including language generation. The present disclosure further relates to retrieval-augmented generation (RAG) which may refer to a technique for improving the accuracy and reliability of generative AI models, such as LLMs, using data retrieved from external sources (e.g., outside of the models'training data).

### BACKGROUND

LLMs allow generating various types of natural language documents, which may include text as well as visual data (e.g., images, video, tables, charts, graphs, etc.). Using RAG, LLMs may be able to generate documents incorporating specific information retrieved from various external sources. Thus, RAG may allow customization as well as improved accuracy using LLMs to generate documents.

However, it may be desirable to generate specific documents containing different types of content, such as a combination of text and tables, and/or retrieve information from different types of content documents, such as from a written report and a source code document. Because LLMs are often trained on a particular type of content or are otherwise limited in training for different types of content, LLMs may not perform well at generating such documents having different types of content, even with applying RAG. Further, RAG techniques often do not consider different types of content.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of an example system for document analysis for machine learning models.

FIG. 2 is a block diagram of an example network for document analysis for machine learning models.

FIG. 3 is a diagram of examples stages for document analysis for machine learning models.

FIG. 4 is a flow diagram of one of the example stages relating to natural language content.

FIG. 5 is a flow diagram of one of the example stages relating to computer code content.

FIG. 6 is a flow diagram of the example stages for document analysis for machine learning models.

FIG. 7 is a flow diagram of one of the example stages relating to a document template.

FIG. 8 is a flow diagram of one of the example stages relating to table formatting.

FIG. 9 is a flow diagram of an example method for document analysis for machine learning models.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Machine learning/artificial intelligence, in particular language models such as large language models (LLMs) may be used to generate documents (e.g., also referred to a generative AI). One technique for generative AI includes retrieval augmented generation (RAG), which may use an LLM to reference a specified set of documents to augment the LLM's own training data, and generate output. The RAG process often includes various stages, such as indexing the specified set of documents, retrieving the most relevant documents from the specified set (e.g., in response to a query/prompt), augmenting the original query with the retrieved documents, and generating an output based on the query and retrieved documents.

However, LLMs exhibit certain limitations with respect to the RAG process. For example, conventional indexing may produce sub-optimal retrieval and augmentation. LLMs may also struggle with generating outputs in particular document formats. Further, documents of different content types (e.g., natural language versus computer code) may exacerbate such issues.

The present disclosure is generally directed to multi-chain generative artificial intelligence (GenAI) that allows for improved RAG for multiple language types. As will be explained in greater detail below, embodiments of the present disclosure may preprocess documents into separate document databases for different language/content types, prompt a different language model for each language/content type to retrieve relevant documents and generate document summaries, and produce a formatted document as output. The systems and methods described herein may advantageously improve the functioning of a computer itself by more efficient storage of tokenized documents, reducing network communications (e.g., between servers hosting models), and/or improved usage of computing resources such as processors and memory (e.g., by improving performance and reducing processing iterations for generating documents). In addition, the systems and methods provided herein may improve the technical fields of generative AI, RAG, and language models, by providing more efficient and effective processing of different language/content types for combining in a single output document. Moreover, the systems and methods provided herein may provide specific rules that allow automation of specific RAG tasks that conventionally are not automated, further improving the RAG process. For example, the systems and methods provided herein allow multiple content-customized RAG processes in parallel, to be combined in a final output document in a format previously not performable by a computer.

Features from any of the embodiments described herein may be used in combination with one another in accordance with the general principles described herein. These and other embodiments, features, and advantages will be more fully understood upon reading the following detailed description in conjunction with the accompanying drawings and claims.

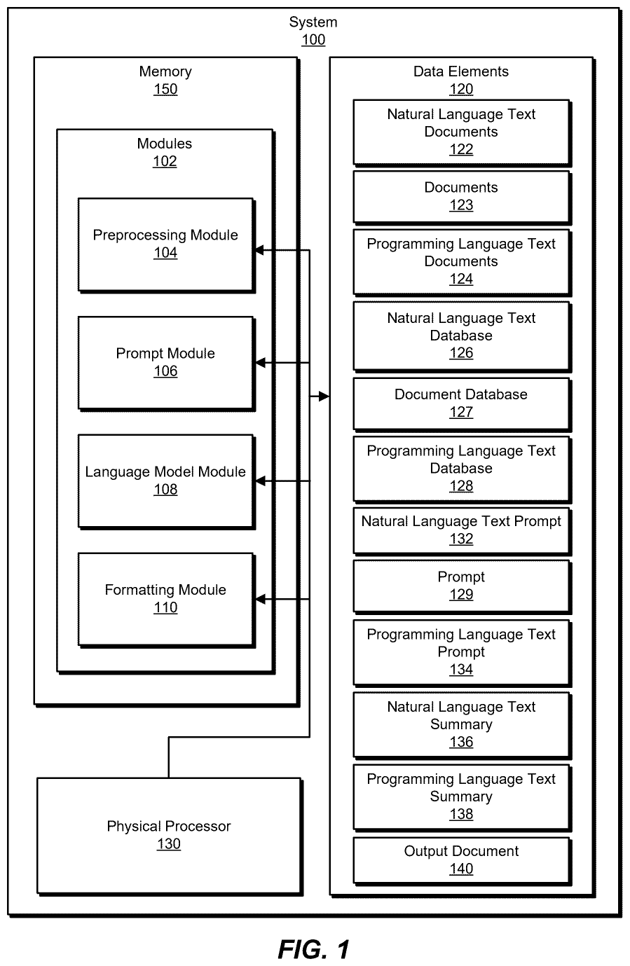

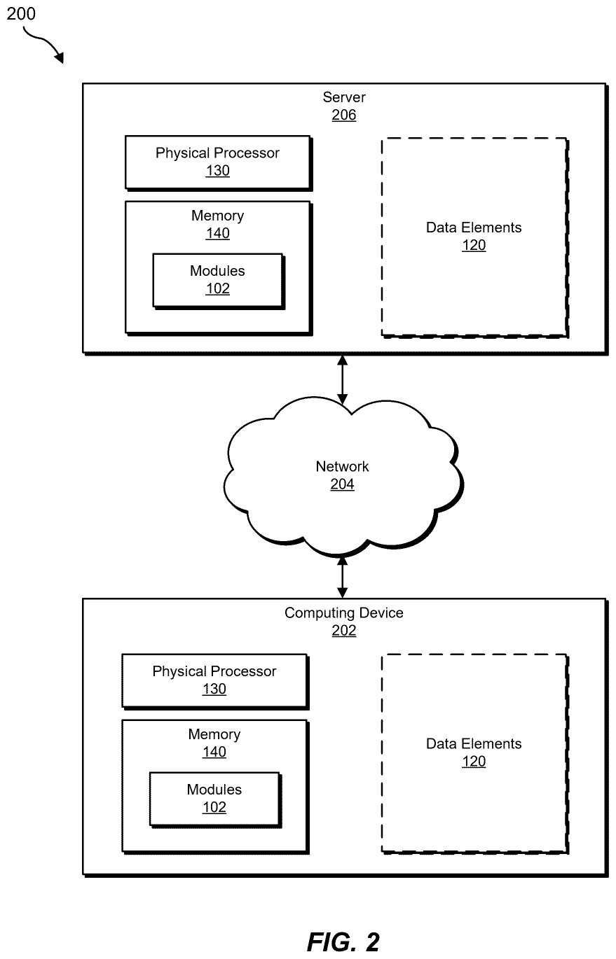

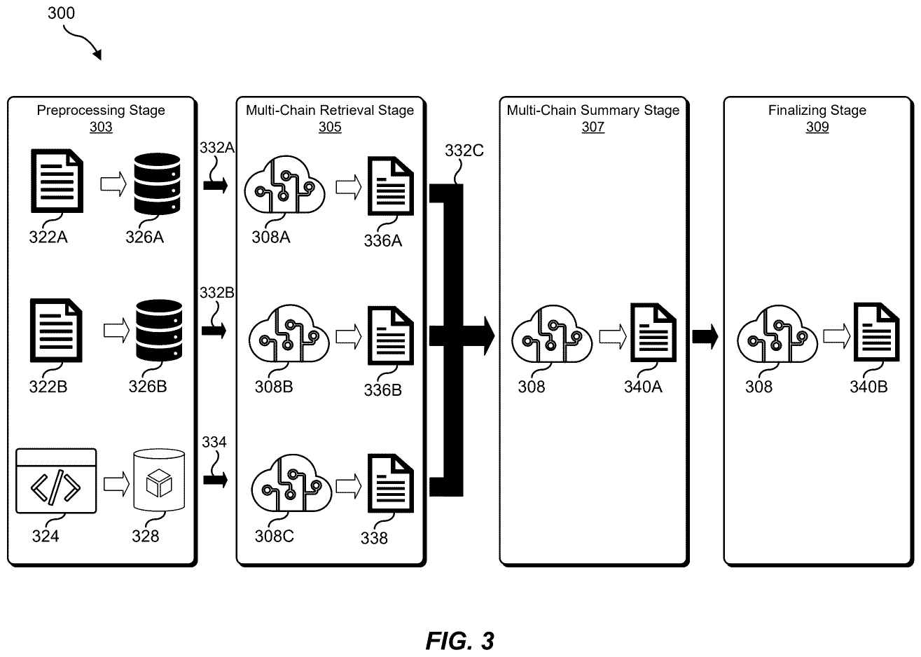

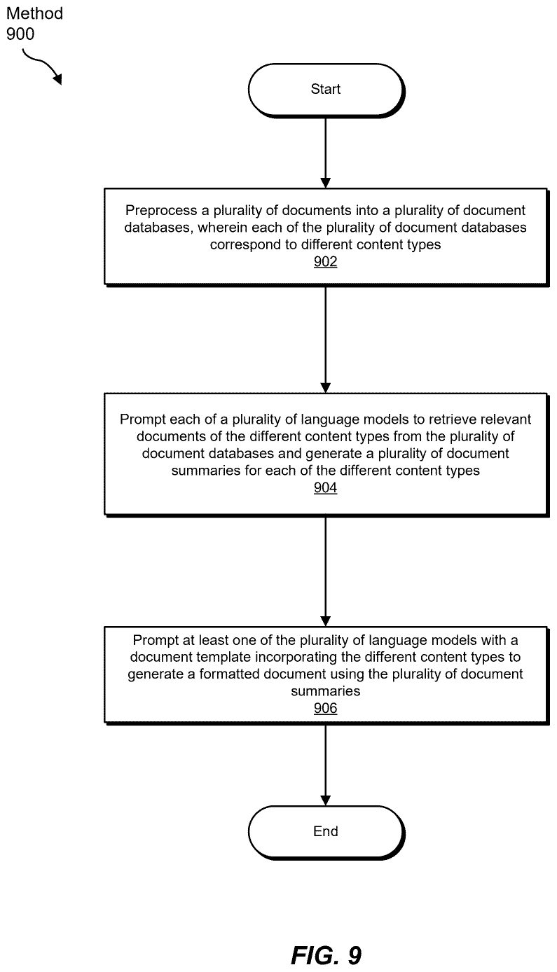

The following will provide, with reference to FIGS. 1-9, detailed descriptions of document analysis and generation for machine learning models. Detailed descriptions of example systems will be provided in connection with FIGS. 1 and 2. Detailed descriptions of example stages for document analysis/generation will be provided in connection with FIGS. 3-8. In addition, detailed descriptions of example computer-implemented methods will be provided in connection with FIG. 9.

Various systems described herein may perform the processes described herein. FIG. 1 is a block diagram of an example system 100 for document analysis and generation for machine learning models. As illustrated in this figure, example system 100 may include one or more modules 102 for performing one or more tasks. As will be explained in greater detail herein, modules 102 may include a preprocessing module 104 (for preprocessing input documents and/or generating document databases), a prompt module 106 (for generating prompts and/or detecting when to prompt language models), a language learning module 108 (e.g., corresponding to one or more language models such as a large language model (LLM) and/or other probabilistic models for natural languages which may further be trained for one or more particular types of content, although in some implementations may generally refer to any generative model), and a formatting module 110 (for modifying generated documents into desired formats). Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks.

As illustrated in FIG. 1, example system 100 may also include one or more memory devices, such as memory 150. Memory 150 generally represents any type or form of volatile or non-volatile storage device or medium capable of storing data and/or computer-readable instructions. In one example, memory 150 may store, load, and/or maintain one or more of modules 102. Examples of memory 150 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 150. Additionally or alternatively, physical processor 130 may execute one or more of modules 102 to facilitate retrieval, augmenting, and/or generating documents. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), graphics processing units (GPUs), hardware accelerators, co-processors, portions of one or more of the same, variations or combinations of one or more of the same, and/or any other suitable physical processor.

As illustrated in FIG. 1, example system 100 may also include one or more additional data elements 120, such as natural language text documents 122, programming language text documents 124, a natural language text database 126, a programming language text database 128, a natural language text prompt 132, a programming language text prompt 134, a natural language text summary 136, a programming language text summary 138, and an output document 140. One or more of data elements 120 may be stored on a local storage device, such as memory 150, or may be accessed remotely. Natural language text documents 122 may represent various types of documents, such as text documents/graphics, websites, slides, files, etc. that may predominantly contain natural language text, as will be explained further below. Programming language text documents 124 may represent text documents/graphics, files, etc. that may predominantly contain computer code and/or other programming language text. Natural language text database 126 may represent one or more databases, repositories, and/or other storage of natural language text documents 122 after processing for language model access. Programming language text database 128 may represent one or more databases, repositories, and/or other storage of programming language text documents 124 after processing for language model access, as will be explained further below. Natural language text prompt 132 may represent one or more prompts for language models that may be configured for accessing natural language text database 126, as will be explained further below. Programming language text prompt 134 may represent one or more prompts for language models that may be configured for accessing programming language text database 128, as will be explained further below. Natural language text summary 136 may represent one or more retrieval-augmented generated documents (e.g., from natural language text database 126 using natural language text prompt 132), as will be explained further below. Programming language text summary 138 may represent one or more retrieval-augmented generated documents (e.g., from programming language text database 128 using programming language text prompt 134), as will be explained further below. Output document 140 may represent one or more finalized output documents (e.g., based on natural language text summary 136 and/or programming language text summary 138, although in some examples may generally refer to any intermediary and/or final generated document as prompted), as will be explained further below. In addition, although FIG. 1 illustrates separate elements, one or more of data elements 120 may be combined and/or otherwise overlap, for example natural language text documents 122 and programming language text documents 124 corresponding to different portions of a same document/file.

In addition, although the examples herein refer to natural language and programming language type documents (and corresponding databases and prompts, etc.), in other examples other types of content/documents may be used. In some implementations, data elements 120 may include documents 123 (e.g., generally representing any type of document or content), a document database 127 (e.g., generally representing any database, repository, and/or other storage of documents 123 after processing for language model access), and a prompt 129 (e.g., generally representing one or more prompts for language models that may be configured for accessing document database 127, as will be explained further below).

Example system 100 in FIG. 1 may be implemented in a variety of ways. For example, all or a portion of example system 100 may represent portions of example network environment 200 in FIG. 2.

FIG. 2 illustrates an exemplary network environment 200 implementing aspects of the present disclosure. The network environment 200 includes computing device 202, a network 204, and server 206. Computing device 202 may be any computing device, including a client device or user device, such as a desktop computer, laptop computer, tablet device, smartphone, or other edge computing device that may access a server. Computing device 202 may include a physical processor 130, which may be one or more processors, memory 150, which may store data such as one or more of additional elements 120, as well as other input and/or output devices not illustrated (e.g., keyboard, mouse, touchscreen, display, etc.).

Server 206 may represent or include one or more servers capable of hosting language models. Server 206 may be any computing device, such as a distributed server, a web server, a database server, a file server, an application server, a virtual machine server, and/or any other virtual and/or physical server. Server 206 may, in some examples, communicate with computing device 202 for retrieving, analyzing, augmenting, and/or generating documents as described herein. Server 206 may include a physical processor 130, which may include one or more processors, memory 150, which may store modules 102, and one or more of additional elements 120.

Computing device 202 may be communicatively coupled to server 206 through network 204. Network 204 may represent any type or form of communication network, such as the Internet, and may comprise one or more physical connections, such as LAN, and/or wireless connections, such as WAN. In some implementations, computing device 202 may access resources (e.g., machine learning models such as language model module 110 and/or various documents and databases as described herein such as data elements 120) hosted by server 206 and further may provide instructions (e.g., prompts as described herein) to server 206, and server 206 may return generated output to computing device 202. Moreover, in some examples, computing device 202 and server 206 may correspond to the same physical and/or virtual computing device.

FIG. 3 illustrates various stages for a multi-chain document generation process 300 for multiple language/content types, which in some examples may correspond to RAG for natural language and programming language types. The examples herein are multi-chain, which may refer to a process including parallel concurrent (e.g., at least partially contemporaneous) sequences. FIG. 3 includes a preprocessing stage 303, a multi-chain retrieval stage 305, a multi-chain summary stage 307, and a finalizing stage 309.

Preprocessing stage 303 may include preprocessing documents for various language types, such as natural language text documents 322A (corresponding to examples of natural language text documents 122), natural language text documents 322B (corresponding to more examples of natural language text documents 122), and programming language text documents 324 (corresponding to examples of programming language text documents 124). These documents may be preprocessed into respective databases, such as natural language text database 326A (corresponding to an example of natural language text database 126), natural language text database 326B (corresponding to another example of natural language text database 126), and programming language text database 328 (corresponding to an example of programming language text database 128), as illustrated in FIG. 3. In some examples, at least a portion of preprocessing stage 303 may be performed by language models, such as a language model 308A (corresponding to an example of language model module 108 that may be configured for natural language processing of a first type of natural language documents), a language model 308B (corresponding to another example of language model module 108 that may be configured for natural language processing of a second type of natural language documents), and/or a language model 308C (corresponding to yet another example of language module 108 that may be configured for programming language processing of computer code documents/files).

Although the examples herein may refer to natural language documents and programming language documents, in other examples, the first and second types of documents may include, alternatively refer to, or otherwise represent other types of documents, including more than two types of documents (e.g., as represented by documents 123 and/or document database 127). Language model 308A, and/or any other model described herein, may convert documents 123 into document database 127 (e.g., by tokenizing, vectorizing, embedding, etc.). In some examples, documents 123 may correspond to video and/or audio files having spoken words and/or other sounds that are recognized (e.g., via speech recognition and/or other sound processing), tokenized and accordingly indexed into document database 127. In some examples, documents 123 may correspond to video and/or image files having objects (e.g., as detected via computer vision) and indexed accordingly into document database 127. In some examples, documents 123 may correspond to documents having more than one type of content, such as a combination of text, visual data, and/or audio data, that may be appropriately indexed into document database 127.

In some examples, preprocessing may include tokenizing the text into tokens that may be embedded to vectors for storing into a database. Tokenizing may include breaking up input text (e.g., natural language text documents 322A, natural language text documents 322B, and/or programming language text documents 324) into subword units or tokens, which may be assigned a specific index number. The tokens may be passed through a language model, which may include an embedding layer and/or transformer block(s). The embedding layer of a language model may convert tokens into dense vectors to capture semantic meanings. A vector may include (for each indexed token) numerical values representing a specific feature of the input data, which captures the semantic meanings from the input data in a format that the model (e.g., transformer block) may process. In some examples, the vectors may be stored in vector databases (e.g., databases configured for storing and querying vector embeddings, which in some examples may be represented by natural language text database 326A, natural language text database 326B, and/or programming language text database 328). The transformer block by process the embedding vectors for understanding context, and also for generating results/output (which may be detokenized into output text).

FIG. 3 generally illustrates multiple parallel chains for preprocessing stage 303, for example for different types of language content. In some examples, natural language text documents 322A (and the chain stemming therefrom) may correspond to summary text documents (e.g., prior versions/iterations of summary text documents similar to a type of summary document to be output from process 300). In other words, natural language text documents 322A may correspond to documents that may be predominantly natural language, and semantically similar to an intended style/format to be output from process 300 (e.g., an output document 340B which may correspond to a finalized example of output document 140, which in some examples corresponds to a natural language document which summarizes various input documents, although in other examples may correspond to other formats). Accordingly, the various models, prompts, and/or other features of the chain stemming from natural language text documents 322A may be configured for its particular language/content type.

In some examples, natural language text documents 322B (and the chain stemming therefrom) may correspond to example text documents (e.g., documents having natural language and/or graphics providing conceptual examples in a format/style that may be different from that of a document to be output from process 300). In other words, natural language text documents 322B may correspond to documents that may include natural language as well as other types of content (e.g., charts, graphics, tables, etc.), and semantically different from an intended style/format to be output from process 300 (e.g., output document 340B). Accordingly, the various models, prompts, and/or other features of the chain stemming from natural language text documents 322B may be configured for its particular language/content type.

In some examples, programming language text documents 324 (and the chain stemming therefrom) may correspond to computer code documents (e.g., documents having predominantly text following a programming language format that may be different from a natural language format of a document to be output from process 300). In other words, programming language text documents 324 may correspond to documents that may include predominantly computer code and/or pseudocode (e.g., description of an algorithm to be coded using programming language conventions informally), and semantically different from an intended style/format to be output from process 300 (e.g., output document 340B). Accordingly, the various models, prompts, and/or other features of the chain stemming from programming language text documents 324 may be configured for its particular language/content type. In addition, although FIG. 3 illustrates three chains (e.g., two different types of natural language content and programming language content), in other examples additional or fewer chains (corresponding to different combinations of language/content types) may be used.

Chunking the input data may provide more efficient RAG processing (e.g., improved retrieval quality, reduced vector database cost and query latency, reduced LLM latency and hallucinations). Chunking may involve breaking down (e.g., partitioning or otherwise splitting) input text documents into smaller, more manageable pieces (e.g., chunks), which may define a unit of information that may be vectorized and stored in a database (e.g., vector databases as described above). Conventional chunking may apply general chunking rules to input documents (e.g., maintaining a fixed size). However, improved chunking may provide further efficiencies to RAG processing.

As described above, process 300 may include multiple types of language content. Accordingly, each of the chains illustrated for preprocessing stage 303 may include custom chunking tailored to the specific language/content type. As illustrated in FIG. 3, each type of language may be stored in its own database, which may involve a preprocessing engine (e.g., preprocessing module 104) having a customized splitter for each content type (e.g., corresponding to variations of preprocessing module 104). For example, natural language text documents 322A may be portioned into segments (e.g., chunked) based on heuristics for maintaining section structure and/or section name (e.g., based on formatting metadata in the document, based on contextual analysis, etc.). In some examples, document metadata, such as heading levels, heading titles, levels, etc., may be used for delineating chunks as well as identifying a chunk name (e.g., a title for the chunk).

Natural language text documents 322B may also be portioned into segments based on heuristics for maintaining sections (e.g., based on graphics and nearby/related text, etc.). Further, programming language text documents 324 may be portioned into segments based on heuristics for maintaining code sections (e.g., based on code syntax structure, etc.). Once appropriately chunked, the chunks may be tokenized and stored in vector databases (e.g., natural language text database 326A, natural language text database 326B, and programming language text database 328, respectively). These databases may be used for multi-chain retrieval stage 305.

Multi-chain retrieval stage 305 may be initiated by a prompting engine (e.g. prompt module 106) prompting the various language models (e.g., language model 308A, language model 308B, and/or language model 308C) with particular prompts that may be configured for particular language/content types. The prompts may include, for example, a natural language text prompt 332A (corresponding to an example of natural language text prompt 132 configured for summary documents), a natural language text prompt 332B (corresponding to an example of natural language text prompt 132 configured for example documents), and a programming language text prompt 334 (corresponding to an example of programming language text prompt 134). The prompts described herein may, in some examples, correspond to a repository of accessible prompts that may be selected and/or modified based on a desired output document. For instance, a user may select a desired type of document to be generated and the system (e.g., prompt module 106) may select and apply appropriate prompts, which may be based on predetermined prompt selections, dynamically selecting prompts (e.g., using language model module 108 and/or another analysis engine to determine/modify prompts as needed), as well as user configurable parameters (e.g., which types of language/content, specific references, etc.). In the examples described herein, the output document may correspond to a description of a machine learning model, with corresponding examples of prompt, although in other examples, the output document may correspond to other types of documents.

As illustrated in FIG. 3, natural language text prompt 332A may be configured to retrieve relevant documents from natural language text database 326A to produce a natural language text summary 336A (corresponding to an example of natural language text summary 136 being a summary document). In some examples, natural language text prompt 332A may include instructions to describe specific aspects (e.g., a brief description of a model purpose, a use case, business requirements, etc.) which may include further instructions to control the output (e.g., outputting section content only, do not chat, do not include any title, greeting, comment, etc.) which may further allow the output (e.g., natural language text summary 336A) to be directly used later in the process.

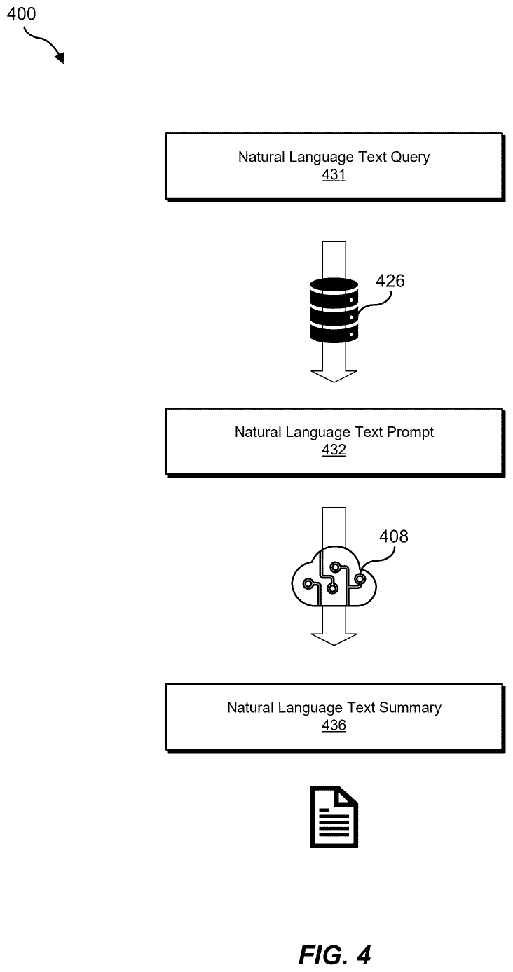

FIG. 4 further illustrates a process 400 corresponding to a natural language chain of multi-chain retrieval stage 305. FIG. 4 includes a natural language text query 431 (corresponding to an example of natural language text prompt 132) for retrieving documents from a natural language text database 426 (corresponding to natural language text database 126). In some examples, natural language text query 431 may represent an initial prompt or template defining a desired output based on the type of document/document database to be accessed, which in some implementations may be a template allowing parameters (e.g., tone, context, output limitations such as length, specific questions to be answered, instructions to access natural language text database 426, etc.) to be filled to generate a natural language text prompt 432 (corresponding to an example of natural language text prompt 132). In some examples, natural language text query 431 may be predetermined (e.g., as selected from a repository of prompt engineered queries based on document type), although in other examples, may be generated and/or updated by a language model 408 (corresponding to an example of language model module 108 configured for natural language). Natural language text query 431 (and accordingly natural language text prompt 432) may be configured to efficient and accurate retrieval from documents (e.g., including instructions to retrieve particular sections and/or topics from the natural language documents). After a system (e.g., system 100 and/or an agent/engine thereof) uses natural language text query 431 to generate natural language text prompt 432, the system may prompt, using natural language text prompt 432, language model 408 to use the retrieved documents to produce a natural language text summary 436 (corresponding to an example of natural language text summary 136).

Returning to FIG. 3, natural language text prompt 332B may be configured to retrieve relevant documents from natural language text database 326B to produce a natural language text summary 336B (corresponding to another example of natural language text summary 136). In some examples, natural language text prompt 332B may include instructions to describe specific aspects (e.g., a summary of a model purpose and use case for an executive summary section, etc.) which may include further instructions to control the output (e.g., finding, copying, and outputting the relevant section/subsection without modification) which may further allow the output (e.g., natural language text summary 336B) to be directly used later in the process. In some examples, this chain may be another example of FIG. 4.

As further illustrated in FIG. 3, programming language text prompt 334 may be configured to retrieve relevant documents from programming language text database 328 to produce a programming language text summary 338 (corresponding to an example of programming language text summary 138). In some examples, programming language text prompt 334 may include instructions to describe specific aspects (e.g., asking to find the values for metrics used to measure model performance on training and test data, evaluating the code to compare with other models, etc.) which may include further instructions to control the output (e.g., treating questions independently, producing no output if the answer is unknown, etc.) which may further allow the output (e.g., programming language text summary 338) to be directly used later in the process.

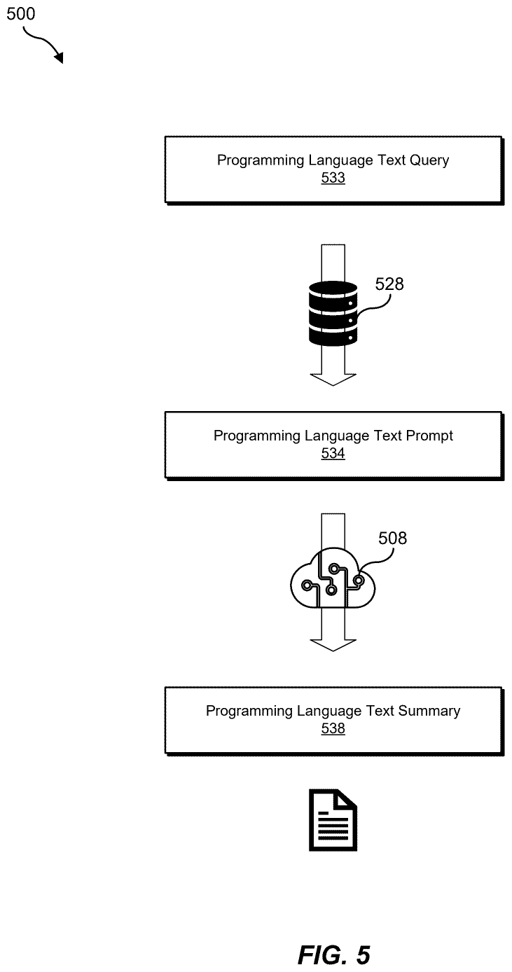

FIG. 5 further illustrates a process 500 corresponding to a programming language chain of multi-chain retrieval stage 305. FIG. 5 includes a programming language text query 533 (corresponding to an example of programming language text prompt 134) for retrieving documents from a programming language text database 528 (corresponding to programming language text database 128). In some examples, programming language text query 533 may represent an initial prompt or template defining a desired output based on the type of document/document database to be accessed, which in some implementations may be a template allowing parameters (e.g., tone, context, output limitations such as length, specific questions to be answered, instructions to access programming language text database 528, etc.) to be filled to generate a programming language text prompt 534 (corresponding to an example of programming language text prompt 134). In some examples, programming language text query 533 may be predetermined (e.g., as selected from a repository of prompt engineered queries based on document type), although in other examples, may be generated and/or updated by a language model 508 (corresponding to an example of language model module 108 configured for programming language). Programming language text query 533 (and accordingly programming language text prompt 534) may be configured to efficient and accurate retrieval from documents (e.g., including instructions to retrieve particular code sections and/or definitions from the programming language documents). After a system (e.g., system 100 and/or an agent/engine thereof) uses programming language text query 533 to generate programming language text prompt 534, the system may prompt, using programming language text prompt 534, language model 508 to use the retrieved documents to produce a programming language text summary 538 (corresponding to programming language text summary 138).

Returning to FIG. 3, in other examples, multi-chain retrieval stage 305 may include other chains for other types of documents. For example, prompt 129 can be configured for one or more of the language models (e.g., language model 308A, language model 308B, and/or language model 308C) to access document database 127, which may include instructions to retrieve particular content/topics (e.g., a specified image, spoken words, sounds, etc.) as well as instructions for particular output (e.g., tone, context, specific questions to be answered, other output limitations, etc.).

Continuing with FIG. 3, in some examples, multi-chain summary stage 307 may be triggered once the various chains produce their respective documents (e.g., natural language text summary 336A, natural language text summary 336B, and programming language text summary 338). In some examples, because the chains may operate in parallel (e.g., independently and/or concurrently) the prompting engine (e.g., prompt module 106) may monitor the respective models (language model 308A, language model 308B, and language model 308C) to detect when all of the prompts have returned results. In some implementations, all of the prompts may need to produce output before continuing to the next stage.

Continuing to multi-chain summary stage 307, the prompting engine may select a natural language text prompt 332C (corresponding to another example of natural language text prompt 132 that may be configured for combining different summary documents and more particularly summary documents of different content types). The prompting engine may prompt a language model 308 (corresponding to an example of language model module 108) with natural language text prompt 332C for combining the outputs of multi-chain retrieval stage 305 (e.g., natural language text summary 336A, natural language text summary 336B, and programming language text summary 338) to produce an output document 340A (corresponding to an example of output document 140 that may represent an initial or rough draft output). In some examples, natural language text prompt 332C may include instructions to describe specific aspects (e.g., producing a summary document etc.) which may include further instructions to control the output (e.g., using only the output of the previous phase, providing examples/templates for document format and tone, no chat, no introduction, etc.) which may further allow the output (e.g., programming language text summary 338) to be directly used later in the process.

In other examples, the prompting engine may select an instance of prompt 129 that may be configured for combining different summary documents (and/or other intermediary documents) of different content types to produce an instance of output document 140, representing a generated output (e.g., another intermediary document and/or a final document) of a same and/or different content type. Output document 140 may share one or more of the document types as the retrieved documents (e.g., from multi-chain retrieval stage 305), although in other examples may have a different document type (e.g., a different type and/or different combination of types). For example, output document 140 may correspond to a text-based summary of various video/audio files, a video that summarizes text, a spoken audio file that summarizes video and text, an image including text that summarizes audio, and so forth. Further, although the examples herein refer to summarizing, summarizing may generally refer to any generation of data from retrieved documents.

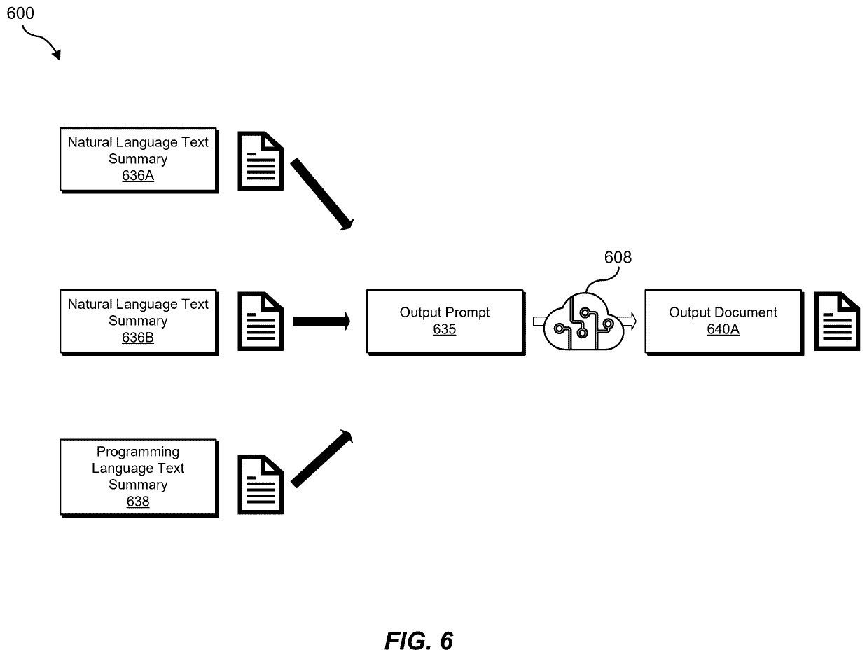

FIG. 6 further illustrates a process 600 corresponding to an example of multi-chain summary stage 307. A natural language text summary 636A (corresponding to an example of natural language text summary 136), a natural language text summary 636B (corresponding to another example of natural language text summary 136), and a programming language text summary 638 (corresponding to an example of programming language text summary 138) may be used, with output prompt 635 (corresponding to an example of natural language text prompt 132) by a language model 608 (corresponding to an example of language model module 108) to generate an output document 640A (corresponding to another example of output document 140 that may represent an initial or unformatted output). In some examples, output prompt 635 may include instructions for producing output document 640A, such as a format and/or tone (which may reference prior documents and/or templates), and further limitations to the output (e.g., do not chat or have an introduction, using only the input documents/context provided, etc.)

The prompting engine may detect when process 600 (e.g., multi-chain summary stage 307) completes (e.g., producing output document 640A corresponding to output document 340A) to optionally continue to finalizing stage 309. In some examples, output document 340A may correspond to a desired output (e.g., the summary document as originally selected). However, in other examples, output document 340A may need further finalizing, such as further formatting (e.g., to fit a desired template/format), including elements other than textual blocks (e.g., graphics, tables, etc.) and/or other modifications. Traditionally, language models may not effectively produce such formatting, such as having difficulty in generating tables (particularly using computer code as a source), as well as formatting documents combining different content types.

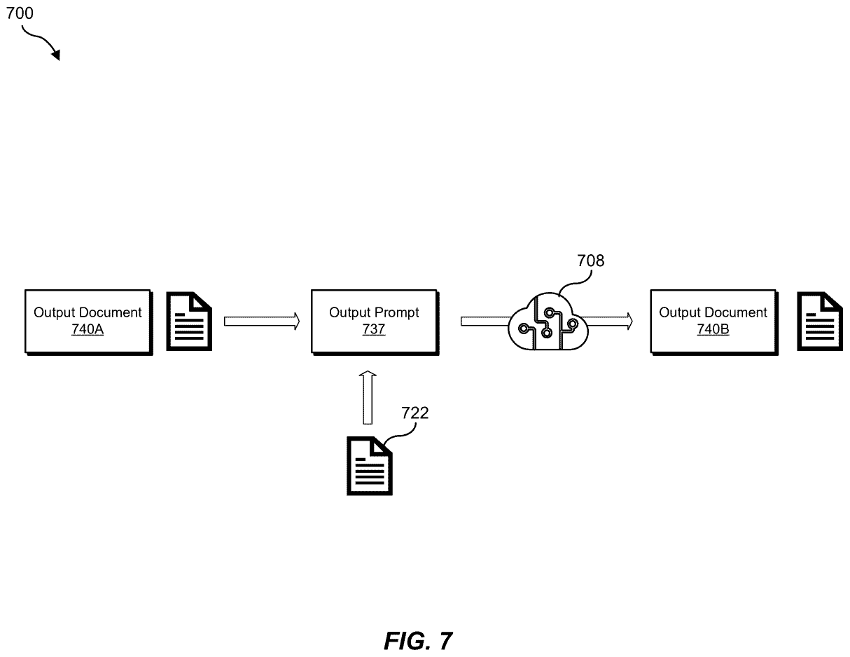

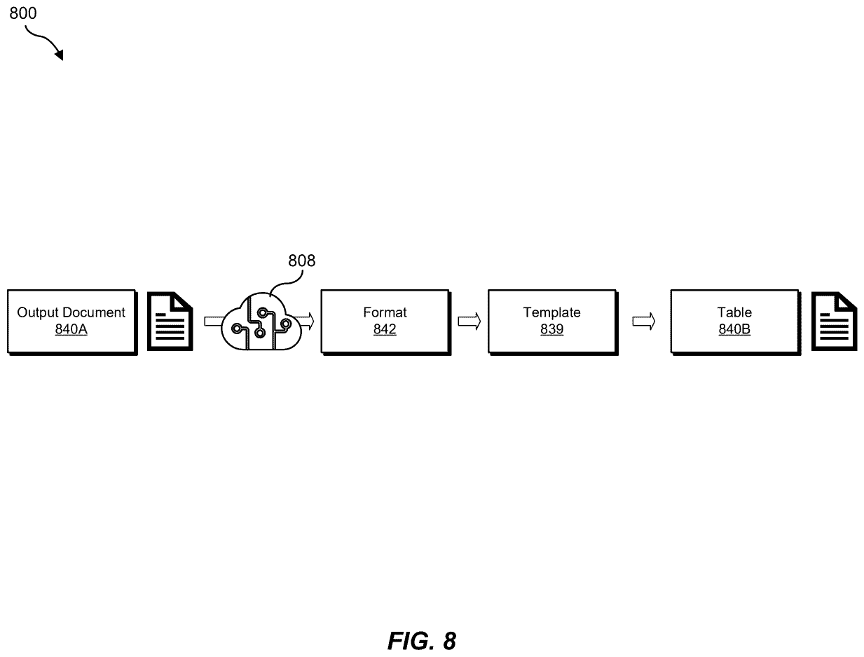

Finalizing stage 309 may involve prompting language model 308 to produce an output document 340B (corresponding to another example of output document 140 that may represent a finalized output) based on various finalizing/formatting processes described with respect to FIGS. 7 and 8. Although the finalizing described below may refer to text-based finalizing, in other examples, the finalizing may be configured for the type of output (e.g., having audio/video-based finalizing such as cropping elements, cutting elements, rearranging elements, speeding up/slowing down elements, normalizing volume, etc.).

FIG. 7 illustrates a process 700 of a formatting portion of the chain. An output document 740A (corresponding to another example of output document 140 that may represent an initial output) may be used as input for an output prompt 737 (corresponding to an example of natural language text prompt 132). More specifically, in some examples, output prompt 737 may prompt a language model 708 (corresponding to an example of language model module 108) by referring to a particular section in output document 740A. Output prompt 737 may also reference an example document 722 (corresponding to an example of natural language text document 122) which, in some examples, may correspond to a previous example and/or a template document. More specifically, in some examples, output prompt 737 may instruct language model 708 to fill in portions defined by example document 722 with corresponding information from output document 740A (e.g., the template corresponding to a framework document with headings/sections to be filled in by relevant information from output document 740A). For instance, output prompt 737 may correspond to prompt engineered instructions, such as indicating which portions of output document 740A to use for particular sections of example document 722, formatting instructions, etc., to ensure accurate document generation with consistent results that may conform to example document 722. Accordingly, language model 708 may generate an output document 740B (corresponding to another example of output document 140 that may represent a finalized output).

In some examples, process 700 may correspond to natural language text portions. Certain sections may require a modified process, such as for programming language text portions, as will be discussed with respect to FIG. 8.

FIG. 8 illustrates a process 800 of another formatting portion of the chain. In some examples, FIG. 8 represents formatting tables or other text that is not presented in sentence/paragraph form. Moreover, in some examples, FIG. 8 corresponds to formatting computer code into tables. An output document 840A (corresponding to another example of output document 140 that may represent an initial output) may include sections having programming language text. A language model 808 (corresponding to an example of language model module 108), may be configured for programming language text, and may extract the same from output document 840A into a format 842 (corresponding to standard format which may present parameters/variables and values from the extracted computer code in an enumerated format). Language model 808 may transfer the information from format 842 into a template 839 (e.g., an example document such as example document 722, which in some examples may correspond to a formatted empty table). For instance, language model 808 may insert the parameters/variables into rows, include corresponding values into matching columns, and further apply appropriate headers, to produce a table 840B (e.g., corresponding to a table portion of output document 140). In some examples, language model 808 may be prompted by a prompt (e.g., output prompt 737) to generate table 840B.

Returning now to FIG. 3, finalizing stage 309 may include the various formatting processes described herein, which in some examples may be performed section by section for output document 340B. In some examples, the different formatting processes (e.g., as illustrated in FIGS. 7 and 8) may use different language models and therefore be performed in parallel (e.g., similar to multi-chain retrieval stage 305). Accordingly, the prompting engine may detect when the formatting processes are complete, in order to present output document 340B.

FIG. 9 is a flow diagram of an exemplary computer-implemented method 900 for multi-chain generative AI. The steps shown in FIG. 9 may be performed by any suitable computer-executable code and/or computing system, including the system(s) illustrated in FIGS. 1 and/or 2. In one example, each of the steps shown in FIG. 9 may represent an algorithm whose structure includes and/or is represented by multiple sub-steps, examples of which will be provided in greater detail below.

As illustrated in FIG. 9, at step 902 one or more of the systems described herein may preprocess a plurality of documents for indexing into a plurality of document databases. Each of the plurality of document databases may correspond to different content types. In some examples, preprocessing module 104 may preprocess natural language text documents 122 for indexing into natural language text database 126, and preprocess programming language text documents 124 for indexing into programming language text database 128. In addition and/or alternatively, preprocessing module 104 may preprocess documents 123 for indexing into document database 127.

The systems described herein may perform step 902 in a variety of ways. In one example, preprocessing the plurality of documents may include categorizing each document of the plurality of documents based on the different content types (e.g., natural language summary documents, natural language example documents, programming language documents, video files, audio files, etc.), chunking the plurality of documents into a plurality of variable-sized chunks based on one or more heuristics (e.g., based on document structure, sentence/paragraph structure, topic/theme, etc.), storing the plurality of variable-sized chunks as embeddings (e.g., vector embeddings) into the plurality of document databases (e.g., vector databases separated by content type) and indexed based on the categorizing.

In some examples, chunking the plurality of documents may include identifying a chunk name for each of the plurality of variable-sized chunks based on a content of each chunk (e.g., associated a title to the chunk as applied with the heuristics), and associating each of the plurality of variable-sized chunks with the corresponding chunk name (e.g., storing the title and/or appropriate embedding with the vector representing the chunk).

In some examples, chunking the plurality of documents may further include identifying a document section from the document (e.g., using the heuristics described herein), and creating a chunk based on the identified document section.

At step 904 one or more of the systems described herein may prompt each of a plurality of language models to retrieve relevant documents of the different content types from the plurality of document databases and generate a plurality of document summaries for each of the different content types. For example, prompt module 106 may prompt language model module 108 (e.g., an instance thereof configured for natural language) with natural language text prompt 132 to retrieve relevant documents (e.g., chunks) from natural language text database 126 and generate natural language text summary 136, and prompt language model module 108 (e.g., an instance thereof configured for programming language) with programming language text prompt 134 to retrieve relevant documents (e.g., chunks) from programming language text database 128 and generate programming language text summary 138. In addition and/or alternatively, prompt module 106 may prompt language model module 108 (and/or any other appropriate generative model) with prompt 129 to retrieve relevant documents (and/or portions thereof) from document database 127 and generate an output document (such as an instance of output document 140).

The systems described herein may perform step 904 in a variety of ways. In one example, prompting each of the plurality of language models further comprises prompting each of the plurality of language models in parallel such that the plurality of language models retrieves the relevant documents and generate the plurality of document summaries concurrently. For instance, prompt module 106 may prompt the different instances of language model module 108 in parallel rather than in sequence (e.g., rather than waiting on one model to finish before prompting the next model). For instance, prompting each of the plurality of language models in parallel may include applying one of a plurality of prompts corresponding to each of the different content types of the plurality of document databases. As described herein, the different content types may include at least natural language text and programming language text, and the plurality of prompts may include a prompt configured for natural language text (e.g., natural language text prompt 132) and a prompt configured for programming language text (e.g., programming language text prompt 134). In addition, the plurality of language models may include at least a language model configured to receive the prompt configured for natural language text and a language model configured to receive the prompt configured for programming language text.

In some examples, prompt module 106 (and/or formatting module 110) may identify when each of the applied ones of the plurality of prompts completes generating corresponding ones of the plurality of document summaries. For example, prompt module 106 may identify when all of the requested summary documents (e.g., natural language text summary 136 and programming language text summary 138) are returned. Prompt module 106 (and/or formatting module 110) may, in response to the identifying, prompt at least one of the plurality of language models with a specified format, which in some examples may also be part of step 906.

At step 906 one or more of the systems described herein may prompt at least one of the plurality of language models with a document template incorporating the different content types to generate a formatted document using the plurality of document summaries. For example, prompt module 106 and/or formatting module 110 may prompt language model module 108 with a document template (e.g., a variation of natural language text prompt 132) to generate output document 140 using natural language text summary 136 and programming language text summary 138. Formatting module 110 may perform further finalizing of output document 140 as described herein.

The systems described herein may perform step 906 in a variety of ways. In one example, prompt module 106 may prompt the at least one of the plurality of language models with the document template using a prompt for converting programming language text into a table format (see, e.g., FIG. 8). In some examples, generating the formatted document using the plurality of document summaries may include prompting (e.g., by prompt module 106) the at least one of the plurality of language models (e.g., one or more variations of language model module 108) to combine the plurality of document summaries (e.g., natural language text summary 136 and programming language text summary 138) into a summary document (e.g., output document 140) incorporating the different content types and prompting the at least one of the plurality of language models to reformat the summary document to conform with the document template (see, e.g., FIG. 7).

As detailed above, a Model Development Document (MDD) is a comprehensive technical summary of a machine learning/AI model, which covers the essential facts of a model, including model use case, business needs, methodology, performance, monitoring plan, etc. In some regulated industries, such as banking, finance, and insurance, an MDD may be useful for complying with regulation and ensure that models are compliant as well as function as intended.

Traditionally, composing a MDD requires consolidating information (e.g. project confluence pages, model development code, strategy decks, previous MDDs) from multiple sources, which can be an inefficient process for a person, and not feasible to reliably perform using automated tools as it may require consolidating different types of information, such as prior version of the MDD, new strategy use case, new technical enhancement as described in code, etc.

The systems and methods provided herein may leverage Large Language Models (LLMs) to generate MDD. The systems and methods described herein provide customized chains to handle the full-loop generation of MDD, including multi-source information retrieval, multi-stage summarization, automatic formatting, etc.

For example, the chains may include (as described above), using LLMs to compose the MDD, multi-source context to assist generation (retrieval augmented generation, RAG), using prompts section by section that may be reused for future use cases without requiring manual intervention, etc.

Additional improvements include, for example (and as described above), an improvement to a langchain recursive character text splitter which rather that splitting by chunk size, may keep complete sentences, further allowing the ability to mix sections/pages. As MDD content may be highly section dependent, traditional retrieval accuracy (from traditional chunking) may be low. A customized splitter as provided herein may therefore maintain section structure and section name, and add as title for each chunk, to improve retrieval accuracy.

In some aspects, the techniques described herein relate to a system including: a processor; and a non-transitory computer-readable medium having stored thereon instructions that are executable by the processor to cause the system to perform operations including: partitioning a plurality of natural language text documents into a plurality of natural language text partitions for a natural language text database; partitioning a plurality of computer code text documents into a plurality of computer code text partitions for a computer code text database; searching, using a first language model, the natural text database and generating a natural language text summary; searching, using a second language model, the computer code text database and generating a computer code text summary; generating, using the first language model, a summary document combining the natural language text summary and the computer code text summary; and converting, using the first language model, at least a portion of the computer text summary in the summary document into one or more tables.

In some aspects, the techniques described herein relate to a system, wherein partitioning the plurality of natural language text documents is based on context-based breaks identified within the plurality of natural language text documents.

In some aspects, the techniques described herein relate to a system, wherein converting at least the portion of the computer text summary into the one or more tables is based on a set of document parameters defining the one or more tables.

In some aspects, the techniques described herein relate to a system, wherein the instructions further cause the system to perform operations including: tokenizing the plurality of natural language text partitions for storing in the natural language text database; and tokenizing the plurality of computer code text partitions for storing in the computer code text database.

In some aspects, the techniques described herein relate to a non-transitory computer-readable medium having stored thereon instructions that are executable by a processor of a computing system to cause the computing system to perform operations including: dividing a first set of documents of a first text format into a first plurality of variable-sized chunks; converting the first plurality of variable-sized chunks into a first set of vectors stored in a first database of the first text format; dividing a second set of documents of a second text format into a second plurality of variable-sized chunks; converting the second plurality of variable-sized chunks into a second set of vectors stored in a second database of the second text format; parsing, using one or more language models, the first database to create a first text summary; parsing, using the one or more language models, the second database to create a second text summary concurrently with creating the first text summary; and merging, using the one or more language models, the first text summary and the second text summary into a summary document.

In some aspects, the techniques described herein relate to a non-transitory computer-readable medium, wherein the instructions further include instructions for: dividing a third set of documents in a third text format into a third plurality of variable-sized chunks; converting the third plurality of variable-sized chunks into a third set of vectors stored in a third database of the third text format; parsing, using the one or more language models, the third database to create a third text summary concurrently with creating the first text summary and the second text summary; and merging, using the one or more language models, the third text summary with the first text summary and the second text summary into the summary document.

In some aspects, the techniques described herein relate to a non-transitory computer-readable medium, wherein the first text format corresponds to text with graphics, the second text format corresponds to computer code, and the third text format corresponds to previously generated summary documents.

In some aspects, the techniques described herein relate to a non-transitory computer-readable medium, wherein a first language model of the one or more language models is configured for retrieval-augmented generation of the first text format and a second language model of the one or more language models is configured for retrieval-augmented generation of the second text format.

In some aspects, the techniques described herein relate to a non-transitory computer-readable medium, wherein the instructions further include instructions for reformatting, using the one or more language models, the summary document to comply with a document requirement template to produce a final summary document.

In some aspects, the techniques described herein relate to a computer-implemented method including: preprocessing a plurality of documents for indexing into a plurality of document databases, wherein each of the plurality of document databases correspond to different content types; prompting each of a plurality of language models to retrieve relevant documents of the different content types from the plurality of document databases and generate a plurality of document summaries for each of the different content types; and prompting at least one of the plurality of language models with a document template incorporating the different content types to generate a formatted document using the plurality of document summaries.

In some aspects, the techniques described herein relate to a method, wherein preprocessing the plurality of documents includes: categorizing each document of the plurality of documents based on the different content types; chunking the plurality of documents into a plurality of variable-sized chunks based on one or more heuristics; and storing the plurality of variable-sized chunks as embeddings into the plurality of document databases and indexed based on the categorizing.

In some aspects, the techniques described herein relate to a method, wherein chunking the plurality of documents further includes: identifying a chunk name for each of the plurality of variable-sized chunks based on a content of each chunk; and associating each of the plurality of variable-sized chunks with the corresponding chunk name.

In some aspects, the techniques described herein relate to a method, wherein chunking the plurality of documents further includes: identifying a document section from the document; and creating a chunk based on the identified document section.

In some aspects, the techniques described herein relate to a method, wherein prompting each of the plurality of language models further includes prompting each of the plurality of language models in parallel such that the plurality of language models retrieve the relevant documents and generate the plurality of document summaries concurrently.

In some aspects, the techniques described herein relate to a method, wherein prompting each of the plurality of language models in parallel further includes applying one of a plurality of prompts corresponding to each of the different content types of the plurality of document databases.

In some aspects, the techniques described herein relate to a method, wherein the different content types include at least natural language text and programming language text, and the plurality of prompts includes a prompt configured for natural language text and a prompt configured for programming language text.

In some aspects, the techniques described herein relate to a method, wherein the plurality of language models includes at least a language model configured to receive the prompt configured for natural language text and a language model configured to receive the prompt configured for programming language text.

In some aspects, the techniques described herein relate to a method, wherein prompting the at least one of the plurality of language models with the document template includes a prompt for converting programming language text into a table format.

In some aspects, the techniques described herein relate to a method, further including: identifying when each of the applied ones of the plurality of prompts completes generating corresponding ones of the plurality of document summaries; and prompting at least one of the plurality of language models with a specified format in response to the identifying.

In some aspects, the techniques described herein relate to a method, wherein generating the formatted document using the plurality of document summaries includes: prompting the at least one of the plurality of language models to combine the plurality of document summaries into a summary document incorporating the different content types; and prompting the at least one of the plurality of language models to reformat the summary document to conform with the document template.

As detailed above, the computing devices and systems described and/or illustrated herein broadly represent any type or form of computing device or system capable of executing computer-readable instructions, such as those contained within the memory devices described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), hardware accelerators, graphics processing units (GPUs), co-processors, portions of one or more of the same, variations or combinations of one or more of the same, or any other suitable physical processor.

Although described/illustrated as separate elements, the instructions described and/or illustrated herein may represent portions of a single instruction, code, program, and/or application. In addition, in certain embodiments one or more of these instructions may represent one or more software applications or programs that, when executed by a computing device, may cause the computing device to perform one or more tasks. For example, one or more of the instructions described and/or illustrated herein may represent instructions stored and configured to run on one or more of the computing devices or systems described and/or illustrated herein. One or more of these instructions may also represent all or portions of one or more special-purpose computers configured to perform one or more tasks.

In addition, one or more of the modules described herein may transform data, physical devices, and/or representations of physical devices from one form to another. For example, one or more of the instructions recited herein may receive document data to be transformed, transform the data into token vectors, output a result of the transformation to generate documents, use the result of the transformation to analyze documents for prompts, and store the result of the transformation to maintain embeddings. Additionally or alternatively, one or more of the instructions recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a processor; and
a non-transitory computer-readable medium having stored thereon instructions that are executable by the processor to cause the system to perform operations comprising:
partitioning a plurality of natural language text documents into a plurality of natural language text partitions for a natural language text database;
partitioning a plurality of computer code text documents into a plurality of computer code text partitions for a computer code text database;
searching, using a first language model, the natural text database and generating a natural language text summary;
searching, using a second language model, the computer code text database and generating a computer code text summary;
generating, using the first language model, a summary document combining the natural language text summary and the computer code text summary; and
converting, using the first language model, at least a portion of the computer text summary in the summary document into one or more tables.

2. The system of claim 1, wherein partitioning the plurality of natural language text documents is based on context-based breaks identified within the plurality of natural language text documents.

3. The system of claim 1, wherein converting at least the portion of the computer text summary into the one or more tables is based on a set of document parameters defining the one or more tables.

4. The system of claim 1, wherein the instructions further cause the system to perform operations comprising:
tokenizing the plurality of natural language text partitions for storing in the natural language text database; and
tokenizing the plurality of computer code text partitions for storing in the computer code text database.

5. A non-transitory computer-readable medium having stored thereon instructions that are executable by a processor of a computing system to cause the computing system to perform operations comprising:
dividing a first set of documents of a first text format into a first plurality of variable-sized chunks;
converting the first plurality of variable-sized chunks into a first set of vectors stored in a first database of the first text format;
dividing a second set of documents of a second text format into a second plurality of variable-sized chunks;
converting the second plurality of variable-sized chunks into a second set of vectors stored in a second database of the second text format;
parsing, using one or more language models, the first database to create a first text summary;
parsing, using the one or more language models, the second database to create a second text summary concurrently with creating the first text summary; and
merging, using the one or more language models, the first text summary and the second text summary into a summary document.

6. The non-transitory computer-readable medium of claim 5, wherein the instructions further comprise instructions for:
dividing a third set of documents in a third text format into a third plurality of variable-sized chunks;
converting the third plurality of variable-sized chunks into a third set of vectors stored in a third database of the third text format;
parsing, using the one or more language models, the third database to create a third text summary concurrently with creating the first text summary and the second text summary; and
merging, using the one or more language models, the third text summary with the first text summary and the second text summary into the summary document.

7. The non-transitory computer-readable medium of claim 6, wherein the first text format corresponds to text with graphics, the second text format corresponds to computer code, and the third text format corresponds to previously generated summary documents.

8. The non-transitory computer-readable medium of claim 5, wherein a first language model of the one or more language models is configured for retrieval-augmented generation of the first text format and a second language model of the one or more language models is configured for retrieval-augmented generation of the second text format.

9. The non-transitory computer-readable medium of claim 5, wherein the instructions further comprise instructions for reformatting, using the one or more language models, the summary document to comply with a document requirement template to produce a final summary document.

10. A computer-implemented method comprising:
preprocessing a plurality of documents for indexing into a plurality of document databases, wherein each of the plurality of document databases correspond to different content types;
prompting each of a plurality of language models to retrieve relevant documents of the different content types from the plurality of document databases and generate a plurality of document summaries for each of the different content types; and
prompting at least one of the plurality of language models with a document template incorporating the different content types to generate a formatted document using the plurality of document summaries.

11. The method of claim 10, wherein preprocessing the plurality of documents comprises:
categorizing each document of the plurality of documents based on the different content types;
chunking the plurality of documents into a plurality of variable-sized chunks based on one or more heuristics; and
storing the plurality of variable-sized chunks as embeddings into the plurality of document databases and indexed based on the categorizing.

12. The method of claim 11, wherein chunking the plurality of documents further comprises:
identifying a chunk name for each of the plurality of variable-sized chunks based on a content of each chunk; and
associating each of the plurality of variable-sized chunks with the corresponding chunk name.

13. The method of claim 11, wherein chunking the plurality of documents further comprises:
identifying a document section from the document; and
creating a chunk based on the identified document section.

14. The method of claim 10, wherein prompting each of the plurality of language models further comprises prompting each of the plurality of language models in parallel such that the plurality of language models retrieves the relevant documents and generate the plurality of document summaries concurrently.

15. The method of claim 10, wherein prompting each of the plurality of language models in parallel further comprises applying one of a plurality of prompts corresponding to each of the different content types of the plurality of document databases.

16. The method of claim 15, wherein the different content types include at least natural language text and programming language text, and the plurality of prompts includes a prompt configured for natural language text and a prompt configured for programming language text.

17. The method of claim 16, wherein the plurality of language models includes at least a language model configured to receive the prompt configured for natural language text and a language model configured to receive the prompt configured for programming language text.

18. The method of claim 17, wherein prompting the at least one of the plurality of language models with the document template includes a prompt for converting programming language text into a table format.

19. The method of claim 15, further comprising:
identifying when each of the applied ones of the plurality of prompts completes generating corresponding ones of the plurality of document summaries; and
prompting at least one of the plurality of language models with a specified format in response to the identifying.

20. The method of claim 10, wherein generating the formatted document using the plurality of document summaries comprises:
prompting the at least one of the plurality of language models to combine the plurality of document summaries into a summary document incorporating the different content types; and
prompting the at least one of the plurality of language models to reformat the summary document to conform with the document template.
